(19) United States
(12) Patent Application Publication
(10) Pub. No.: US 2004/0059759 A1
(43) Pub. Date: Mar. 25, 2004

(54) Persistent unique and flexible object addressing mechanism for data in a part memory and part disk environment

(76) Inventors: Tuan V. Doan, San Jose, CA (US); Jean A. Hassoun, San Jose, CA (US); Pradiptya Ghosh, San Jose, CA (US); Sylvain Rene?apos; Yves Louboutin, Mount Hamilton, CA (US); Robert J. Walsh, Sunnyvale, CA (US)

Correspondence Address: MARTINE & PENILLA, LLP, 710 LAKEWAY DRIVE, SUITE 170, SUNNYVALE, CA, 94085, US

(21) Appl. No.: 10/252,729

(22) Filed: Sep. 23, 2002

(51) Int. Cl. G06F 17/30; G06F 12/00

(52) U.S. Cl. 707/205

(57) ABSTRACT

A system for resolving object address. A computer-implemented method for resolving addresses in a computing system includes dynamically assigning a library identifier to a database stored on a secondary storage medium and obtaining a database identifier for each of a number of objects stored in the database, appending the library identifier to each of the database identifiers to generate a unique reference identifier (DRef) for each of the plurality of objects stored in the database. Upon receiving an object request from an application, where the object request identifies one of the plurality of objects by its DRef, the method retrieves the object identified by the object request and stores the object identified by the object request in memory.

### BACKGROUND OF THE INVENTION

1. Field of the Invention

The present invention relates to computing systems and, more particularly, to a method and system for resolving addresses in a part-memory and part-disk computing environment.

2. Description of the Related Art

Data used in the execution of a software application may be stored in memory or stored in a database on disk. If the data is stored on disk, it is accessed by a database id. If a software application is configured to access data from more than one database on disk, an address overlap can occur. That is, two different objects within two different databases can have the same database id. When a database item is loaded into memory, it can be associated with a context pointer in order to distinguish two different database items that have the same database id but come from a different database, or “context.” The context pointer identifies the context from which the data item originates.

What is needed is an object addressing scheme that allows a memory addressing mechanism to apply to both data stored in memory and data stored in a database on disk. In such an environment, something other than the traditional database id and context pointer are required in order to provide an object addressing mechanism for database-stored objects. In such an environment, it would further be desirable for the unique addressing mechanism for database-stored data to be flexible enough so that data retrieved from disk to memory in independent environments can be used without subsequent address space clash in a common environment. A system is therefore required that allows dynamic re-binding of inter-object relationships within the model.

### SUMMARY OF THE INVENTION

Resolving addresses in a computing system including dynamically assigning a library identifier to a database stored on a secondary storage medium, obtaining a database identifier for each of a number of objects stored in the database, appending the library identifier to each of the database identifiers to generate a unique reference identifier (DRef) for each of the plurality of objects stored in the database, receiving an object request from an application, wherein the object request identifies one of the plurality of objects by its DRef, retrieving the object identified by the object request, and storing the object identified by the object request in memory. Resolving addresses in this way allows a software application requiring access to a number of objects stored on a database to efficiently access these objects. This in turn provides the ability to dynamically rebind interchangeable objects; the ability to interface backend databases, and the ability to address an arbitrarily large number of objects.

A further understanding of the nature and advantages of the inventions herein may be realized by reference to the remaining portions of the specification and the attached drawings.

### BRIEF DESCRIPTION OF THE DRAWINGS

The present invention may be better understood, and its numerous objects, features, and advantages made apparent to those skilled in the art by referencing the accompanying drawings.

FIG. 1 is a block data flow diagram illustrating a system that stores a portion of a software model in a software cache.

FIG. 2 is a functional block diagram generally illustrating a method for providing a persistent unique and flexible object addressing mechanism for data in a part-memory and part-disk environment.

FIG. 3 is a block diagram of the bit contents of an exemplary DRef data object comprising n bits.

FIG. 4 is a functional block diagram illustrating creation of a Dwrapper object for a target object 205.

FIG. 5 is a functional block diagram illustrating a method of locking a target object 205 when the object is already in memory.

FIG. 6 is a functional block diagram illustrating a system for locking a target object 205 when the object is already in memory and is represented by a handle in a quick cache lookup table.

FIG. 7 is a functional block diagram illustrating a system for locking a target object 205 when the object is already in memory but is not yet represented by a handle in a quick cache lookup table.

FIG. 8 is a functional block diagram illustrating the retrieval of a target object 205 associated with a DRef from secondary storage when such target object 205 does not already exists in memory.

### DETAILED DESCRIPTION

The following sets forth a detailed description of a mode for carrying out the invention. The description is intended to be illustrative of the invention and should not be taken to be limiting.

Glossary of Terms

context pointer: a pointer that uniquely identifies an item in memory while that item is locked in memory. A context pointer is transient in that its value is only guaranteed to be fixed while an object is locked in memory.

database id: an identifier that uniquely identifies an item with the scope of a given database.

DRef: an identifier that uniquely identifies an item during a session. A DRef is composed of the database id and some identifying information. The identifying information relates to the library in which the item resides. The library identification information for the same library may differ between sessions in the case, for instance, where each session is handling a different set of libraries.

library id: a number arbitrarily assigned to a given library in the set of libraries known to the sessions currently running. The same library may be associated with different library id values across different sessions. Alternatively, different libraries may be associated with the same library id value in different sessions. There exists a one-to-one mapping of library to library id within the scope of a session.

cluster id: identifies a group or “cluster” of items with consecutive database id within a library.

Description of a Preferred Embodiment

An object addressing and caching system, as described below, allows software applications to address a large amount of data in a limited amount of memory. As is well known in the art, the performance of operating systems is quickly degraded when they are required to page data in and out of memory. To address this problem, the system described below creates a unique addressing space for database-stored objects by appending a library identifier (which is uniquely generated in each session for each environment) to the database id to create a “DRef.” The DRef is used for all addressing and storage of the data object with which it is associated. The DRef is an identifier that allows, across multiple libraries (which are stored on disk storage units), unique access to any object that is capable of being stored in a software cache. The system described below allows a software application, such as a computer aided design (CAD) program, to deal with large amounts of data transparently. The system determines whether an object needed by the software application program is stored in the software cache in memory. The system makes the data object available to the program, even if the system must first retrieve the data object from disk. In this manner, the system allows for the application program to perceive that memory addressing space is extended while, in reality, the actual addressing space is limited by the operating system. At the same time, the present invention provides for dynamically rebinding interchangeable objects, the ability to interface various ‘backend’ databases (e.g. different proprietary format databases, and the ability to address arbitrarily large object space).

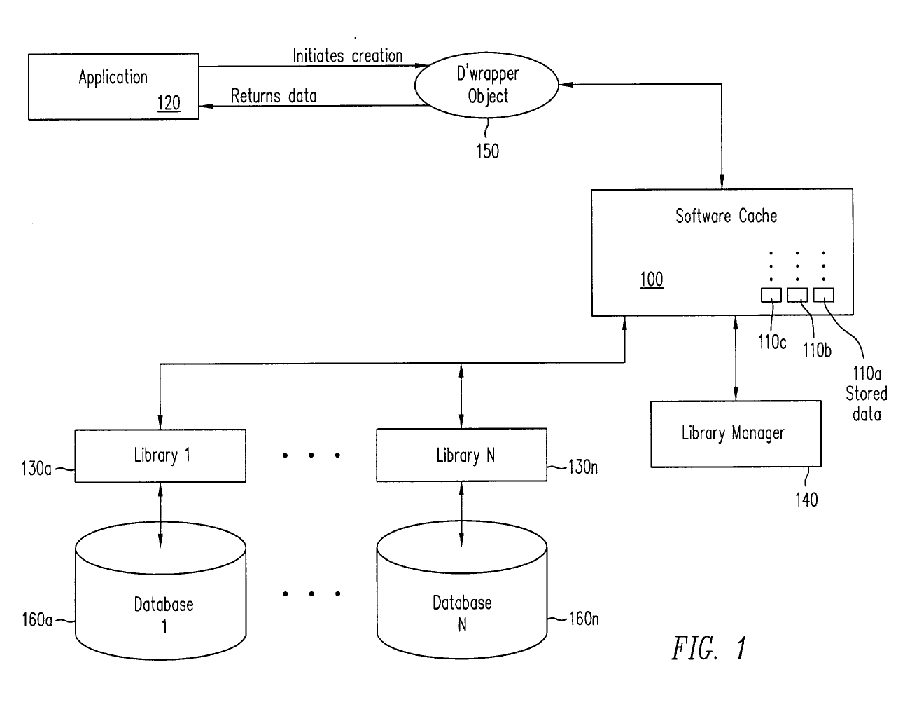

FIG. 1 illustrates a software application program 120 that interacts with stored data 110. Such is often the case in Electronic Design Automation (EDA) and Electronic Computer-Aided Design (ECAD) applications that provide for automated design and verification of digital circuits, such as microprocessors, ASICs (Application Specific Integrated Circuits), and FPGAs (Field Programmable Gate Arrays). A digital circuit under design sometimes is referred to herein as a “model.”

Developers generally utilize one or more hardware description languages, such as Verilog or VHDL, to build a software model that describes the behavior and certain structural elements of the digital circuit under design. The model requires access to one or more libraries 130a through 130n of definitions for existing building blocks that are used to build the digital circuit under design. These building blocks might be, for example, various types of transistors or predefined logic primitives such as AND, OR, and NOT gates and buffers. Libraries 130a, 130n may also store definitions for logic functions such as adders, counters, multiplexers, etc.

It is generally the case that development of a digital circuit involves a development cycle including many phases of development and testing. Various software application programs 120 can be run against the model to perform design and verification functions, such as timing verification. For instance, a timing program can be run to determine which library elements provide the optimum results for the circuit under design. In this situation, a model may invoke different libraries during different phases. For instance, if a developer wishes to determine which of several transistors provides optimum timing, he might run a timing and verification tool against different versions of his model. The first version of this model might incorporate a transistor definition from a first library 130a, while a different version of his model might incorporate a different transistor definition from another library 130n. For this reason, the overall design reflected in the model must be dynamically reconfigurable. That is, objects, or even whole libraries, must be interchangeable. A system is therefore required that allows dynamic re-binding of inter-object relationships within the model.

Typically, the software application program 120 and model are stored on a hard disk of a data processing system until needed. When a software application program 120 is to be executed, it is transferred from the hard disk to the main memory of the data processing system. If the software application program 120 is to be run against the circuit model, the model must be brought into memory as well. While it would be ideal to transfer the entire software definition of the circuit model from hard disk to memory when an application will be executed on the model, there is usually insufficient space in memory to load the entire model into memory. Typically, a model includes various software libraries that are linked together. While one or more of these libraries 130a-130n can be efficiently stored in memory during execution of a software application program 120, it is not usually feasible to store all of them in memory. This situation is true of any software application program 120 that deals with a large amount of data and is not necessarily limited to software application programs 120 that interact with circuit models. Any software application program 120 dealing with a large amount of data must deal with the issue of lack of actual physical memory space for storage of the data.

Often, therefore, a library object must be retrieved from disk rather than from memory. Many EDA and ECAD applications, for example, provide the ability to access libraries provided by other vendors. For instance, an EDA design tool might provide interfaces to libraries created by other EDA vendors such as Cadence, Exemplar Logic, Mentor Graphics, Synopsys, Synplicity, Viewlogic, and others. Often, the application must retrieve the predefined objects stored in libraries from disk. In at least one embodiment, the libraries on disk are saved in a format that is akin to a graph or tree structure. That is, a top (or “root”) node (which may be an object-oriented object) contains references to pointers to other “children” nodes, and so on. The application program must access the disk on which several different libraries may be defined, and pull the desired object from the proper library. The application may be required to retrieve, during the same session, objects from different libraries that reside on the disk.

FIG. 1 illustrates a system including a processor 105 that stores a portion of a software model in a software cache 100. The portion of the model stored in the software cache 100 is referred to as stored data 110. The stored data 110 is retrieved into the software cache 100 from one or more libraries 130a through 130n. During its operation, the software application program 120 retrieves the desired library data from the software cache 100. In this manner, it is transparent to the software application program 120 that portions of library data are stored on hard disk rather than in memory. From the point of view of the software application program 120, the data 110 it needs is capable of being retrieved from the software cache 100.

Each library 130 is, in at least one embodiment, an object-oriented graph structure containing a root node in the graph structure of the library. The root node has references to other nodes in the library. In at least one embodiment, a root node for library “lib1” 130a is referred to as “Lib1.”

Each library 130a through 130n has a unique database id assigned to each object in the library 130. That is, each object in the library 130 is stored in an application database 160a and has a pointer referring to it. The pointer associated with each object is referred to as that object's database id, or “dbid.” When needed by the software application program 120, a particular object can be brought into the software cache 100 (if it is not already in the software cache 100) and accessed via its dbid.

A potential difficulty arises from the fact that independent libraries on disk may each utilize addressing schemes for their library objects that overlap each other. For instance, library A may have an item 1, item 2, and item 3 while library B may also have an item 1, item 2, and item 3. When these two libraries are loaded into memory, they create an overlap situation wherein memory now contains two different item 1s, two different item 2s and two different item 3s.

For example, assume that library 1 130a and library N 130n in FIG. 1 each have an object corresponding to each of the following database ids: db1, db2, and db3. In some prior art systems, the application is required to resolve the address space conflict by keeping track, for instance, of whether the particular object identified by db1 is the object from library 1 or library n. In the system described herein, the system resolves the address space conflict so that the application can not only work transparently through the objects in the two databases without worrying about whether the objects are in memory or on disk, but also without having to resolve the address space conflict.

To resolve the address space conflict, context information is added to the database id for each object in a library when the library is opened by the software application program 120. This process is referred to as creating a DRef for each of the library objects. Using the example above, the DRef for each of the objects associated with database ids a1, a2, and a3 from library 1 is created as well as the DRef for each of the objects associated with database ids a1, a2, and a3 from library n when the libraries are loaded. The DRefs result, in effect, in one of the item 1's being identified as “item 1 from library 1” and the other item 1 is identified as “item 1 from library n.”

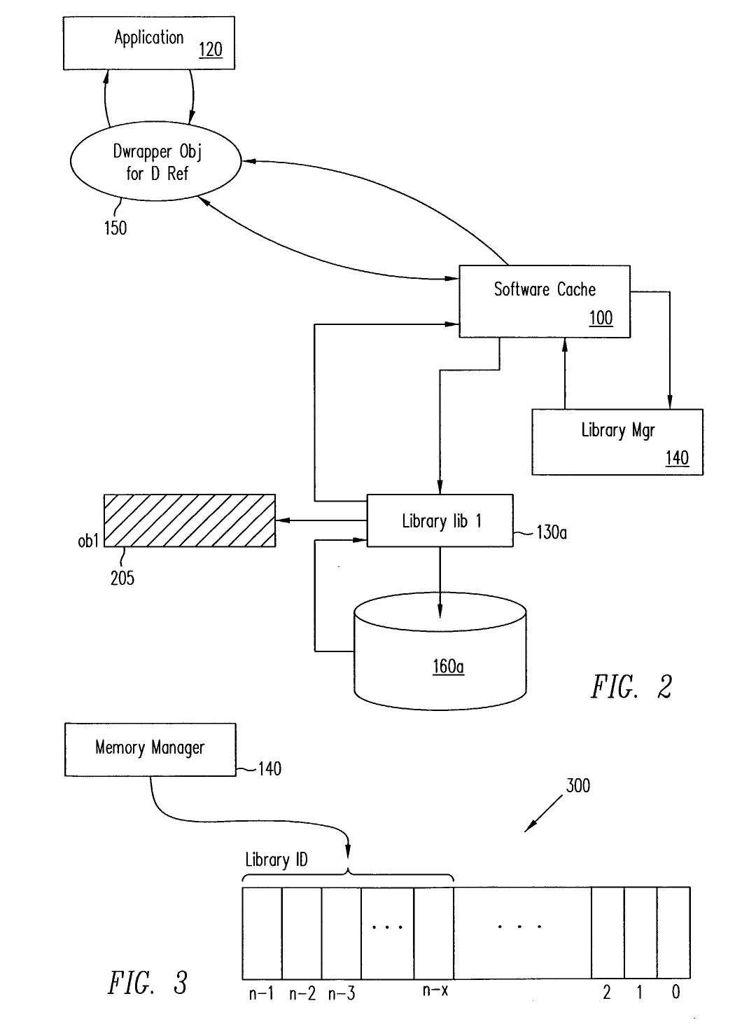

FIGS. 1 and 2 illustrate that, in order to manage the software cache 100 so that stored data 110 from a library 130 is transparently available to the software application program 120, a library manager 140 is provided. The library manager 140 is operable to provide a unique library id (“lib id”) for each of the libraries 130a through 130n that it manages during a particular session. For instance, the lib id for library “lib 1” 130a may correspond to a value of “001” The DRef that is assigned to each library object is based, in part, on the library id assigned to its library by the library manager 140. A DRef is only valid within the scope of a given session, and may change across sessions, although the library id will stay the same.

In at least one embodiment, a DRef is a data object that comprises 32 bits. However, one skilled in the art will recognize that the size of the DRef may be expanded or decreased, as desired, so as long as there are a sufficient number of bits to accommodate the largest address desired in the object addressing scheme disclosed herein. For instance, alternative DRef lengths of 64 or 128 bits can be used. Regardless of the particular bit size chosen for the DRef structure, it will be understood that the object addressing and caching system described herein allows for an arbitrarily large object space to be accessed independently from the underlying operating system's own address space.

In contrast, a library that is created in memory, rather than on disk, already has a unique addressing scheme provided by the operating system. Thus, the challenge is to import disk libraries into memory and resolve address conflicts so that each library object is associated with a unique memory pointer. To do this, more information than just the database id from the disk, and the pointer scheme maintained by the operating system are needed. What is needed is a way to append context information to the database id so that the memory pointer is associated with a unique object in one of the disk libraries.

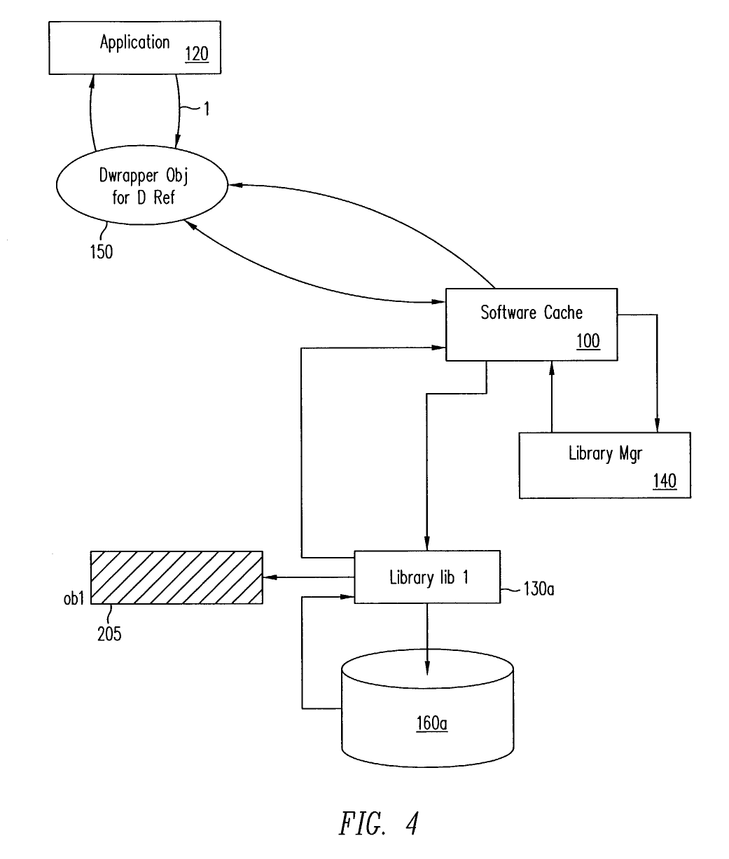

FIG. 3 illustrates the bit contents of an exemplary DRef data object 300 comprising n bits. One skilled in the art will recognize that, while FIG. 3 illustrates that the left-most bits are high-order bits and the right-most bits are the low-order bits, this is not necessarily a requirement. In at least one alternative embodiment, the left-most bits of the DRef data object 300 represent the low-order bits and the right-most bits of the DRef 300 represent the high-order bits.

FIG. 3 illustrates that, in a preferred embodiment, the DRef 300 is configured such that the high-order bits n−1 through n−x, are used to identify the library where the corresponding object belongs. In at least one embodiment, the high-order bits n−1 through n−x are referred to as the library id. In a preferred embodiment, the library id comprises 8 bits, though one skilled in the art will recognize that any appropriate number of bits may be used to represent the library id.

Accordingly, the high-order bits are used to store the library id for the library where the corresponding object belongs. This library id is assigned by the library manager 140 (FIG. 2). A target object 205 may contain other object's database identifications within the same library. When such a target object 204 is mapped into the cache, the database IDs that is contains are translated into valid Drefss on the fly. In a preferred embodiment, the bits of the DRef allocated to hold the library id are only set, and are only meaningful, when the DRef is in memory. DRefs only denote objects belonging to the same library as the object containing it. Accordingly, cacheable objects are denoted by a DRef.

Referring back to FIG. 2, illustrated therein is a typed wrapper object 150 referred to herein as a Dwrapper object. Dwrapper is a template class that provides a constructor, a destructor, and an operator method. An instantiation of the Dwrapper class must be created for an object denoted by a particular DRef in order to access an object that is cached in the software cache 100. The constructor of the Dwrapper object “locks” the target object 205 in the software cache 100. As used herein the target object 205 refers to the object denoted by the DRef. The destructor of the same Dwrapper “unlocks” the target object 205 from the software cache 100. More than one Dwrapper object for a given target object 205 may coexist at any one time.

A target object 205 that is locked in the software cache 100 is guaranteed to remain in memory and is thus more quickly accessible than the same object stored on disk. An object that is no longer locked (i.e., for which no Dwrapper object currently exists) may be removed preemptively from the software cache 100.

FIG. 4 illustrates that an initial operation, referred to as operation 1, in a method for providing a persistent, unique, and flexible object addressing mechanism for data in a part-memory and part-disk environment. As discussed above, the Dwrapper object 150 is associated with the DRef for the target object 205. As a result of creating the Dwrapper object 150 for the target object 205, the target object 205 becomes “locked” in the software cache 100. In at least one embodiment, the Dwrapper is created using the DRef of the target object 205 as an input parameter to the constructor associated with the Dwrapper template class. Accordingly, a Dwrapper object 150 is created for the target object 205, the target object 205 being a cacheable object. A cacheable object is an object that can be cached and dereferenced through the use of a DRef. A lock on a cacheable object may be obtained regardless of whether or not the cacheable object is already in memory. Thus, a target object 205 is uniquely identifiable within the context of a library and database by the database id associated with target object 205. When a software application (e.g., software application 120) needs target object 205, a wrapper is created, a wrapper (e.g., Dwrapper) is created.

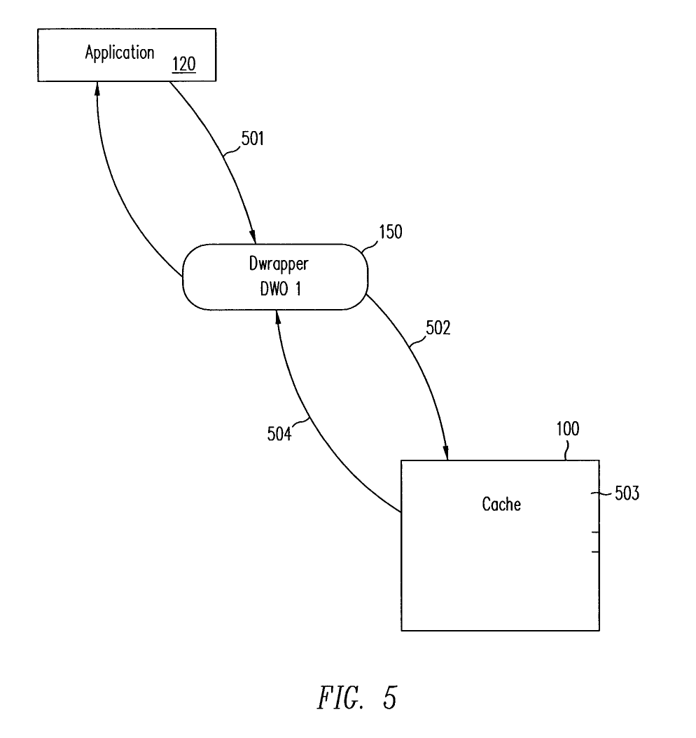

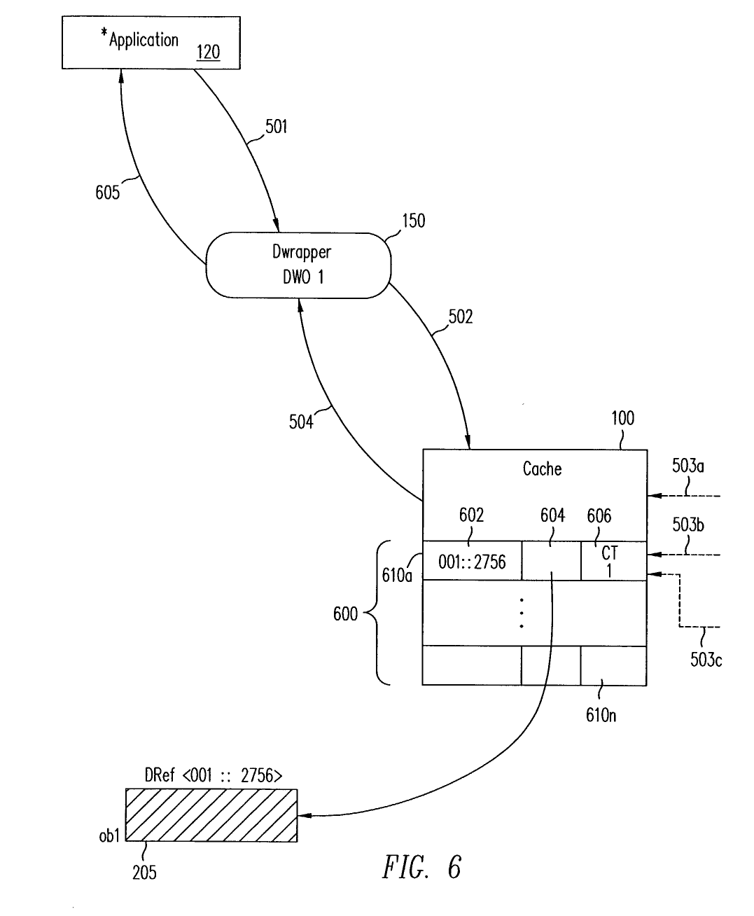

FIG. 5 illustrates a method of locking a target object 205 when the object is already in memory. In an initial operation, referred to as operation 501, creation of a Dwrapper object 150 for the target object 205 is initiated. The Dwrapper object 150 is associated with the DRef for the target object 205. By way of example, FIG. 5 illustrates a DRef for the target object 205, the DRef having a value of <001::2756>. The Dwrapper object 150 is initiated as a result of a request made by the software application program 120. The software application program 120 provides the DRef as a pointer to the object upon which the software application program 120 wishes to operate. As is explained above, the target object 205 associated with the DRef is “locked” in the cache once the Dwrapper object 150 is created. When a cacheable object, such as the target object 205, is thus locked, the software cache 100 cannot flush the line of the software cache 100 containing the target object 205 as long as the Dwrapper object 150 for the target object 205 is in existence.

In operation 502, creation of the Dwrapper is continued. As a result of the operator method associated with the Dwrapper class, a pointer to the object referenced by the DRef is requested of the software cache 100. In operation 503, the software cache 100 searches for the actual address of the target object 205 in memory. If the software cache 100 determines that the target object 205 has not been retrieved from disk into memory, then additional processing must be performed. This additional processing is discussed below in connection with FIG. 8. In either case (i.e., either the target object 205 is already in memory or the target object 205 must be retrieved from disk), the software cache 100 returns a pointer to the target object 205 in memory in operation 504. This pointer is returned to the software application program 120 in the Dwrapper object 150.

FIG. 6 is a functional block diagram illustrating a system for locking a target object 205 when the object is already in memory and is represented by a handle in a quick cache lookup table 600. An index into the quick cache lookup table 600 is associated with the target object 205. In at least one embodiment, an index into the quick cache lookup table 600 is determined from the DRef of the target object 205 in the following manner. The higher order bits of the DRef are masked off so as to obtain an index from the lower bits. In the preferred embodiment, the lower 8 bits of the DRef are used as the index into the quick cache lookup table 600.

The quick cache lookup table 600 is an array of “handles.” A handle is a record made up of three elements: a DRef 602, the actual address 604 of the object in memory, and a lock counter 606.

In operation 503a, the software cache 100 searches the quick cache lookup table 600 to determine whether a valid handle exists for the target object 205. If the entry of the quick cache lookup table 600 indexed by the index obtained from the lower 8 bits of the DRef of the target object 205 contains a handle 610 that contains an identical DRef to the DRef of the target object 205, then the target object 205 is known to already exist in cached memory and the target object 205 is said to have a “valid handle.” In such case, the valid handle is located in operation 503b and the lock counter is incremented in operation 503c.

The memory address 604 of the target object 205 is retrieved from the handle and forwarded to the Dwrapper object 150 in operation 504. The memory address 604 is held as a pointer in a field of the Dwrapper object 150 and is returned to the software application program 120 in operation 605.

In operation 506, the software application program 120 transparently operates on the object associated with the DRef, without accounting for whether the object is in memory or on disk.

The constructor of the newly created Dwrapper object 150 thus increments the lock count 606 for the handle 610a associated with the target object 205. The quick cache lookup table 600 provides handles only for a subset of the objects that may be currently cached in memory. In at least one embodiment, the quick cache lookup table represents a most—recently-used subset of cacheable objects. In this manner, access to most-recently-used cacheable objects is optimized.

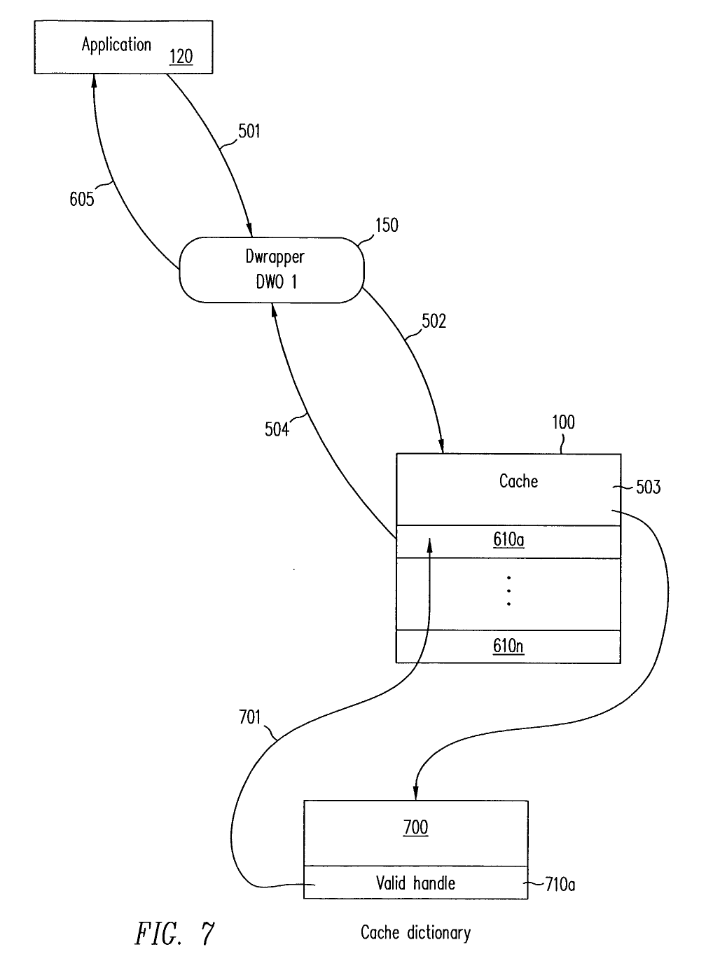

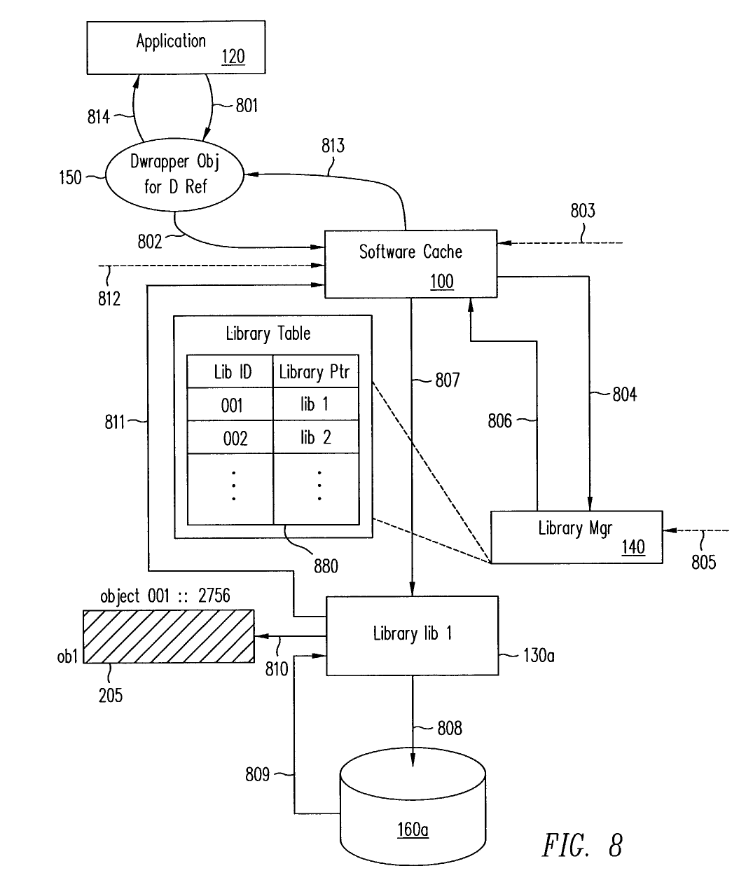

FIG. 7 is a functional block diagram illustrating a system for locking a target object 205 when the object is already in memory but is not represented by a handle in a quick cache lookup table 600 (FIG. 6). The complete set of objects cached in memory at a given time is maintained in a hash table referred to as the cache dictionary 700. In operation 503, the software cache 100 seeks a handle associated with the DRef as discussed above in connection with FIG. 6. If a valid handle is not located, then the software cache 100 searches the cache dictionary 700. Rather than using the lower 8 bits of the DRef as an index in the cache dictionary 700, the software cache 100 uses the entire DRef as an index in the cache dictionary 700. In this manner, the quick cache lookup table 600 (FIG. 6) represents a subset of the information in the cache dictionary 700, in order to provide quicker access to items recently requested by the application (based on the concept of locality of references).

If a valid handle 710a is located in the cache dictionary 700, then the valid handle 710a is placed into the quick cache lookup table 600 at the appropriate index (overwriting the current contents of the quick cache lookup table 600 at that location) in operation 701. In this manner, handles 610 for the most-recently-used cacheable objects are transferred from the cache dictionary 700 and maintained in the quick cache lookup table 600. Thereafter, processing continues as described in connection with FIG. 6.

FIG. 8 is a block diagram illustrating the retrieval of a target object associated with a DRef from secondary storage when such target object 205 does not already exist in memory. The method described in FIG. 8 results in mapping an object to memory from the persistent representation of its library on disk. If a valid handle associated with the DRef of the target object 205 is not located during operation 503 in the quick cache lookup table 600 (FIG. 6), or the cache dictionary 700 (FIG. 7), then it must be retrieved (if it exists) from secondary storage such as disk storage.

A stored version of a target object 205 may only contain the database ID of another object (i.e., the database ID of another target object 205 in the same library.) In such as case, if a target object 205 needs to contain a reference to another target object in another library, the target object in the other library is represented by “proxy” for the library associated with target object 205. When objects are then mapped from their respective libraries into the cache, the proxies are replaced by the actual object. This is how the present invention is able to dynamically rebind interchangeable objects.

As with the valid-handle scenarios discussed above in connection with FIGS. 5, 6, and 7, the software application program 120 initiates creation of a Dwrapper object 150 for the target object 205 in operation 801. In operation 802, the Dwrapper object 150 passes a DRef to software cache 100 and requests a memory pointer from the software cache 100 corresponding to the target object identified by the DRef. In operation 803, the software cache 100 searches for a handle associated with the DRef for the target object 205 in the quick cache lookup table 600 (FIG. 6) and the cache dictionary 700 (FIG. 7) and determines that a valid handle is not found.

In such case, the software cache 100 extracts, in operation 804, a library id from the DRef and forwards such library id to the library manager 140. For the example DRef illustrated in FIG. 8, the library id <001> is extracted from the DRef <001:2756> and is passed to the library manager 140. This operation 804 facilitates an overall object of the software cache 100 in determining which database on secondary storage is to be accessed in order to bring the target object 205 into memory.

The library manager 140, in operation 805, determines which library in secondary storage is associated with the library id forwarded to the library manager 140 in operation 804. This is accomplished, in at least one embodiment, by a look-up in a library table 880. Using the lib id as an index into the library table 880, the library manager 140 locates the library pointer for the library associated with the lib id. In the example illustrated in FIG. 8, the library manager 140 uses the lib id value of “001” as an index into the library table 880 and retrieves the library pointer “lib 1” from the corresponding entry of the library table 880.

In operation 806 the library manager 140 provides the library pointer retrieved as a result of the look-up in the library table 880 to the software cache 100. Library manager 140 is what actually attributes library Ids to the libraries and databases known to the session.

In at least one embodiment, the library whose location is indicated by the library pointer comprises a database 160 and a driver (not shown), such as a Flash™ service. In operation 807, the software cache 100 communicates with the driver to request from the driver a pointer to the target object 205.

In response, the driver accesses the database 160 in operation 808 to locate the target object 205. Information necessary to create an image of the target object 205 is retrieved from the database 160 by the driver in operation 809 and loaded into the library memory image of the driver.

In operation 810, the driver creates an image of the target object 205 in system memory and identifies a pointer (i.e., “ob1”) to the target object 205. In operation 811, the driver returns the pointer (“ob1”) to the software cache 100. In operation 812, the cache makes a cache entry for the pointer in the quick cache lookup table 600 (FIG. 6) and the cache dictionary 700 (FIG. 7). In this manner, a valid handle is created for the target object 205 when it is loaded into system memory. If the handle is created for the newly loaded object in the quick lookup table 600 (FIG. 6), then the lock count may also be set to “true” at this point. However, if the object referenced from the quick lookup table 600 (FIG. 6) was referenced by an application that does not hold a lock on the object, then the lock count will not be set to “true)

In operation 813, the pointer, ob1, to the target object 205 is returned from the software cache 100 to the Dwrapper object 150 for the target object 205. The Dwrapper object 150 stores the pointer in one of its data fields. In operation 814, the Dwrapper object 150 returns the pointer, ob 1, to the software application program 120.

FIG. 8 illustrates that only operations 801 and 814 are visible to the software application program 120. The remainder of the processing illustrated in FIG. 8 is transparent to the software application program 120, which is relieved of any responsibility for determination or processing related to whether the data object on which it wishes to operate is in memory or whether the object is on disk. Accordingly, the system and method described herein result in an addressing scheme that allows for an arbitrarily large object space that spans both in-core (memory) and secondary-storage representations, is independent from the underlying system architecture, and is transparent to the software application program 120.

A background discussion regarding “opening” a library is relevant to further discussion of FIG. 8. Before any Dwrapper object 150 is created as discussed above, the software application program 120 first runs preliminary processing wherein each of the libraries that are to be accessed during its processing are “opened.” Each opened library is associated with its persistent representation in secondary storage. This persistent representation includes a symbol table that correlates a symbol name with its database id or other identifier that specifies the location of the object associated with a given symbol within the database. In at least one embodiment, the persistent representation of a library can also include a cluster ID associated with cluster of cacheable objects. A cluster is a group of cacheable objects within a library that have consecutive database ids. It is anticipated that the cluster of objects will tend to be accessed together by the software application program 120. A cluster ID can be generated, in a least one embodiment, by concatenating the DRefs of the first and last objects in the cluster.

When a library is opened, the symbol table for the database 160 associated with the library is opened and the symbol table is loaded into memory. Thus, while the objects have not yet been loaded into memory, a symbol table having the database id for each object in the database does exist in memory. In order to resolve the address space by making each object unique, even when objects in different databases have the same database id, a library id is assigned to each of the opened databases. A DRef is created for each library object by appending the library id to the database id for each object. The following example is provided for purposes of illustration.

Assume that Library A and Library B are both stored on disk. Further assume that Library A has three objects, a1, a2, and a3. Let the database id of a1 be db1, a2 be db2, and a3 be db3. Library B has three objects, b1, b2, and b3. Let the database id of b1 be db1, b2 be db2, and b3 be db100. After the libraries are loaded in the initial processing for an application, it is desirable for the user to thereafter be able to access the objects in Library A and Library B transparently, without worrying whether a particular object is on disk or in memory. To facilitate such goal, the address space is resolved when Library A and Library B are opened.

If Library A is opened first, it is assigned a library id of 001. If Library B is opened next, it is assigned a library id of 002. The respective objects of the library are thus assigned unique DRefs based on a format of <lib id>:<database id>:

| Object | DRef (unique id) = lib id::database id |
|---|---|
| a1 | 1::db1 |
| a2 | 1::db2 |
| a3 | 1::db3 |
| b1 | 2::db1 |
| b2 | 2::db2 |
| b3 | 2::db100 |

It should be noted that the individual objects need not be loaded into memory, as described above in connection with FIG. 8, in order to have a unique DRef assigned. Hence, references to each object can be made unique even before the objects themselves are loaded into memory. As is described above, a temporary lock is created on a target object 205 by the software cache 100 each time the target object 205 is loaded into the software cache 100 or is thereafter accessed by a Dwrapper object 150. When the application responsible for the lock goes out of context, the lock is destroyed; that is, the lock count for the handle associated with the target object is decremented.

As used herein, care should be taken to distinguish the concept of “going out of context” from the concept of appending “context information” to the database id. Appending context information to the database id means that an identifier representing the particular library associated with the database id is appended to the database id. In contrast, when an application “goes out of context,” the particular session, or run, of the application has terminated.

For any target object whose handle reflects a lock count of zero, all applications that had previously requested the object have gone out of context and the cache is therefore free to flush the handle. In this manner, the user need not resolve the address conflict among libraries; it is transparently handled for him.

The address resolution scheme described herein is not only transparent to the user, but it is dynamic. Continuing with the example above, assume that Library B was loaded before Library A during the initial processing for the software application program 120. In such case, the respective objects of the libraries are assigned the following unique DRefs values:

| Object | DRef (unique id) = lib id::database id |
|---|---|
| a1 | 2::db1 |
| a2 | 2::db2 |
| a3 | 2::db3 |
| b1 | 1::db1 |
| b2 | 1::db2 |
| b3 | 1::db100 |

Accordingly, unlike the database id values, the DRef values are dynamic and can vary from session to session, a “session” being a run of the environment in which the library is loaded. A further advantage of the system and method described herein is that the user is not responsible for resolving the context as would be necessary in an addressing scheme that utilized only the database id values. Furthermore, unlike memory-based systems, all objects of a library need not be loaded into memory in order to resolve the references to the objects.

When a library is opened, a database dictionary for the library is constructed. The database dictionary includes a balanced tree that associates the DRef for a library object to the corresponding cluster id (i.e., to the ID of the cluster likely to contain the object denoted by the DRef).

Referring back to FIG. 8, and with the foregoing background discussion in mind, further discussion of operations 808, 809, 810 and 812 is in order. As stated above, in operation 808 the driver accesses the database to locate the target object. The driver accesses the database dictionary to obtain the cluster ID associated with the database id portion of the DRef for the target object. In at least one embodiment, this mapping of cluster ID to database id is accomplished through the use of a B-tree structure. Using the cluster ID as a key to the database 160, the driver reads the cluster from the database 160 as a raw chunk of bytes in operation 809. This raw chunk of bytes is uncompressed by the driver and its contents are unpickled (i.e., unpickling transforms a cluster—bytes returned from a backend driver—into objects. A ‘class ID’ stored in the header of each object in the cluster determines which unpickling method to use. Each object in the cluster is loaded into the library memory image of the driver. Each object in the cluster is stored with a header that contains the object's own DRef and a class id. The class id is used as an index into an array of functions that creates an object of the appropriate type. This creation occurs in operation 810, wherein the driver creates an image of the target object 205 in system memory and identifies a pointer (i.e., “ob1”) to the object 205. During creation of the object 205, an unpickle method is invoked to read the remainder of the object. If the target object 205 contains DRefs indicating other objects, the DRefs that the object 205 contains are modified when the object 205 is created in memory (this DRef modification process for loaded objects is sometimes referred to as “swizzling”). The modification of the DRefs in the object 205 includes modifying the most significant bits of the DRefs to indicate the library id for library where the object denoted by the DRef resides.

As stated above, the software cache 100 makes a cache entry for the pointer in operation 812. A handle is created for each object read from the cluster being mapped into memory. The handle is entered into both the quick cache lookup table 600 (FIG. 6) and the cache dictionary 700 (FIG. 7).

Mapping a new cluster into memory may necessitate the preemptive unmapping of a lesser-used cluster. The relative use of a cluster by an application is determined via a watermark mechanism. Each leaf of the balanced tree of the database dictionary (that is, each known cluster ID) is linked into a Least Recently Used (“LRU”) list. Newly mapped clusters are placed at the head of the list. Candidates for preemptive unmapping are chosen from the tail of the LRU list. However, a candidate for preemptive unmapping picked from the tail of the LRU list will not be unmapped if it is currently locked in the software cache 100.

In sum, the method and system described herein provide for resolution of addresses for objects in disk-stored libraries (i.e., libraries A and B each have an item 1) and it is done automatically so the user doesn't have to keep track of where the object is coming from, and it is done dynamically so that a particular library may have varying library id's among sessions. Accordingly, an object is uniquely identified within a database when it is stored on disk. When the library is opened, the object, via use of the DRef mechanism, becomes uniquely identified among libraries.

Various advantages of the method and system described herein are apparent. For instance, more objects or entities may be identified than the underlying architecture allows to be identified directly. This feature is particularly advantageous in cases of very large CAD designs, especially those with a potential multitude of interchangeable components. The addressing mechanism described herein is independent from the underlying system limitations and allows dynamic rebinding of inter-object relationships to provide for dynamic reconfiguration of the CAD model. The method and system described herein also allow for transparent interfaces with third party proprietary addressing models, such as exist in third party databases. The method and system described herein make it possible for an application to perform punctual queries and modifications on a portion of a CAD design without requiring the entire design to be read into memory. Those objects specifically required by the application may be loaded. For loaded objects that themselves contain DRefs, it is possible for an object in memory to denote other objects that still reside in secondary storage.

Alternative Embodiments

While particular embodiments of the present invention have been shown and described, it will be recognized to those skilled in the art that, based upon the teachings herein, further changes and modifications may be made without departing from this invention and its broader aspects.

For example, the persistent representation of a library may be stored on any type of secondary storage including, without limitation, hard disk, floppy disk, CD-ROM, magnetic tape, and the like.

Also for example, one skilled in the art will understand that the persistent representation of a library includes at least a database. It may also include a driver, such as the Flash™ driver discussed above. However, any library mechanism known in the art may be utilized to practice the beneficial method and system described herein. Also, for example, the library may also contain a delta file along with the database. The delta file may be used to store preemptively swapped-out clusters of objects. The delta file may also contain a record of those changes to the library not yet implemented in the main database.

As further example, each of the plurality of libraries may reside on the same, or different, secondary storage media.

While particular embodiments of the present invention have been shown and described, it will be recognized to those skilled in the art that, based upon the teachings herein, further changes and modifications may be made without departing from this invention and its broader aspects and, thus, the appended claims are to encompass within their scope all such changes and modifications as are within the true spirit and scope of the invention.

We claim:

1. A method for resolving addresses in a computing system, the computing system having a memory, a processor coupled to the memory, and a secondary storage medium coupled to the memory, the method comprising:
dynamically assigning a library identifier to a database, the database being stored on a secondary storage medium;
obtaining a database identifier for each of a plurality of objects stored in the database;
appending the library identifier to each of the database identifiers to generate a unique reference identifier (DRef) for each of the plurality of objects stored in the database;
receiving an object request from an application, wherein the object request identifies one of the plurality of objects by its DRef;
retrieving an object identified by the object request; and
storing the object identified by the object request in memory.

2. The method recited in claim 1, wherein:
dynamically assigning a library identifier further comprises dynamically assigning a different unique library identifier to each of a plurality of databases, each of the plurality of databases being stored on the secondary storage medium;
obtaining the database identifier further comprises obtaining a database identifier for each of a plurality of objects stored in a selected one of the plurality of databases; and
appending the library identifier further comprises appending the library identifier for the selected database to each of the database identifiers to generate the unique reference identifier (DRef) for each of the plurality of objects stored in the selected database.

3. The method recited in claim 2, wherein each of the plurality of databases is stored on a different one of a plurality of secondary storage media.

4. The method recited in claim 1, wherein retrieving the object identified by the object request further comprises:
generating a handle, wherein the handle further comprises a lock count and the DRef for the object identified by the object request; and
storing the handle in a cache.

5. The method recited in claim 4, further comprising:
determining whether the application is in context; and
providing that the handle may not be flushed from the cache while the application is in context.

6. The method recited in claim 1, wherein retrieving one of the plurality of objects further comprises:
obtaining the object from the database associated with the library identifier.

7. The method recited in claim 2, wherein:
retrieving one of the plurality of objects further comprises:
determining the unique library identifier from the DRef of the object request; and
obtaining the object from the database associated with the library identifier determined from the object request.

8. A method for providing a stored object to an application in a computing system, the computing system having a memory, a processor coupled to the memory, and a secondary storage medium coupled to the memory, the method comprising:
receiving an object request from an application, wherein the object request identifies a target object by a DRef, the DRef comprising a library identifier appended to a database identifier; and
returning a target object pointer, wherein the target object pointer is the address in memory where the target object is located.

9. The method recited in claim 8, further comprising:
opening a plurality of libraries;
loading a library symbol table into memory;
assigning a plurality of libraries identifiers to the plurality of libraries, wherein the plurality of library identifiers includes the library identifier; and
creating the DRef from the library identifier and the database identifier.

10. The method recited in claim 8, wherein returning the target object pointer comprises:
determining whether a handle for the target object resides in a cache;
if a handle for the target object resides in the cache, obtaining the target object pointer from the handle; and
if a handle for the target object does not reside in the cache:
retrieving the target object from the secondary storage medium,
storing the target object in memory, and
obtaining the target object pointer.

11. The method recited in claim 10, wherein if a handle for the target object does not reside in the cache further comprises:
storing the handle in cache;
storing the DRef in the cache, wherein the DRef is an index to the handle.

12. The method recited in claim 10, wherein if a handle for the target object resides in the cache further comprises:
searching a quick cache lookup table for the handle using a subset of bytes of the DRef; and
returning the target pointer if the handles is located.

13. The method recited in claim 12, further comprising:
if the handle is not located in the quick cache lookup table, searching a cache dictionary for the handle, using the DRef as a cache dictionary index;
returning the target pointer if the handle is located; and
retrieving the target object from the secondary storage medium if the target is not located.

14. The method recited in claim 10, wherein the handle comprises:
the Dref;
the target object pointer; and
a lock counter, wherein the lock counter is a count of the number of object requests received.

15. The method recited in claim 14, wherein the lock counter precludes the target object from being overwritten in the cache.

16. The method recited in claim 10, wherein retrieving the object from the secondary storage medium further comprises:
determining the library identifier from the DRef; and
obtaining the object from a database associated with the library identifier, wherein the database is stored on the secondary storage medium.

17. The method recited in claim 16, wherein the obtaining the object from a database comprises:
obtaining a library pointer for the DRef, wherein the library pointer is a pointer to a library on the secondary storage medium in which the target object identified by the DRef resides;
obtaining a cluster id for the DRef;
copying a cluster from the library to memory.

18. The method recited in claim 17, wherein the cluster id comprises:
a first DRef;
a first database id appended to the first DRef;
a last DRef; appended to the first DRef and the first database id; and
a last database id appended to the last DRef.

19. The method recited in claim 17, wherein the cluster comprises:
a plurality of objects, wherein each of the plurality of objects is identified by a unique Dref.

20. A computer program product encoded in computer readable media, the computer program product comprising:
a first set of instructions, executable on a computer system, configured to receive a DRef, wherein:
the DRef includes a database identifier and a library identifier, and
the DRef identifies an object; and
a second set of instructions, executable on the computer system, configured to return an object address, wherein:
the object address is a memory address pointing to where the object is located in memory,
if the object is in a cache, the object address is returned from the cache, and
if the object is not in the cache, the object is mapped into the cache from a secondary storage and the object address is returned from the cache.

21. The computer program product of claim 20, wherein the second set of instructions comprises:
first sub-set of instructions, executable on a computer system, configured to map the object into the cache;
a second sub-set of instructions, executable on the computer system, configured to assign the DRef to the object;
a third sub-set of instructions, executable on a computer system, configured to lock the object into the cache;
a fourth sub-set of instructions, executable on a computer system, configured to dynamically bind a plurality of objects mapped in the cache memory.

22. The computer program product of claim 20, further comprising:
a third set of instructions, executable on the computer system, configured to request the object using the DRef; and
a fourth set of instructions configured to return the object address.

23. An apparatus for resolving a DRef address, comprising:
a processor;
a memory electrically coupled to the processor;
a cache electrically coupled to the processor, the cache having a plurality of storage locations for storing a plurality of cached objects;
a secondary storage electrically coupled to the processor, the secondary storage including a plurality of libraries, wherein each of the plurality of libraries includes a database including a plurality of objects;
means for providing an object address in response to a request for an object, wherein the object address is an address in the memory where the object is located.

24. The apparatus of claim 23, wherein the means for providing an object further comprises:
means for mapping the object from secondary storage to memory;
means for caching said object; and
means for obtaining the object address from the cache.

25. The apparatus of claim 23 further comprising:
means for mapping a library identifier to the object.

26. The apparatus of claim 23 further comprising:
a quick cache lookup table; and
a cache dictionary.
